(19) United States
(12) Patent Application Publication
(10) Pub. No.: US 2013/0013502 A1
(43) Pub. Date: Jan. 10, 2013

(54) Facilitation of Transactions Using a Transaction Code

(75) Inventor: Chris Purvis, Waxhaw, NC (US)

(73) Assignee: Bank of America Corporation, Charlotte, NC (US)

(21) Appl. No.: 13/178,063

(22) Filed: Jul. 7, 2011

(51) Int. Cl. G06Q 20/00

(52) U.S. Cl. 705/42

(57) ABSTRACT

A system includes a memory for storing customer account information associated with first and second customers, and a processor. The processor receives a request to perform a first transaction. In response to a determination that the request to perform the first transaction is approved, the processor generates a first transaction code and transmits the first transaction code to a mobile device associated with the first customer. The processor further receives transaction information for the first transaction. The processor further receives a request to perform a second transaction. In response to a determination that the request to perform the second transaction is approved, the processor generates a second transaction code and transmits the second transaction code to a mobile device associated with the second customer. The processor further receives transaction information for the second transaction. The processor further communicates a batch payment to the particular merchant.

### TECHNICAL FIELD

This disclosure relates generally to the field of transactions and more specifically to the facilitation of transactions using a transaction code.

### BACKGROUND

In order to conduct a transaction with a merchant, a customer typically pays for goods or services received from the merchant using money, a check, and/or credit/debit cards. Payments using credit/debit cards may be problematic for various reasons. For example, credit/debit cards are susceptible to fraud, which can effect the customer, merchant, and/or the financial institution associated with the customer. As another example, credit/debit cards require a merchant to pay substantial fees in order to receive payment for transactions using these credit/debit cards. Since particular merchants may conduct hundreds of thousands of transactions per day using credit/debit cards, these fees may add up very quickly, hurting the profitability of a merchant.

### SUMMARY OF THE DISCLOSURE

According to one embodiment, a system includes a memory for storing customer account information associated with first and second customers, and a processor. The processor receives a request to perform a first transaction. The request to perform the first transaction includes a first payment amount, a first customer identification, and a first merchant identification for a particular merchant. In response to a determination that the request to perform the first transaction is approved, the processor generates a first transaction code based on the first payment amount, the first customer identification, and the first merchant identification; and transmits the first transaction code to a mobile device associated with the first customer. The first transaction code is used to conduct the first transaction. The processor further receives transaction information for the first transaction. The first transaction information includes a first transaction identification, the first payment amount, the first customer identification, and the first merchant identification for a particular merchant. The processor further withdraws the first payment amount from a first customer account. The processor further receives a request to perform a second transaction. The request to perform the second transaction includes a second payment amount, a second customer identification, and a second merchant identification for the particular merchant. In response to a determination that the request to perform the second transaction is approved, the processor generates a second transaction code based on the second payment amount, the second customer identification, and the second merchant identification; and transmits the second transaction code to a mobile device associated with the second customer. The second transaction code is used to conduct the second transaction. The processor further receives transaction information for the second transaction. The second transaction information includes a second transaction identification, the second payment amount, the second customer identification, and the second merchant identification for the particular merchant. The processor further withdraws the second payment amount from a second customer account. The processor further communicates a batch payment to the particular merchant. The batch payment is based at least in part upon the first payment amount and the second payment amount. The batch payment further identifies the first transaction associated with the first payment amount and the second transaction associated with the second payment amount.

Certain embodiments of the disclosure may provide one or more technical advantages. For example, particular embodiments may allow a financial institution device to generate a transaction code for a transaction. As such, a customer may receive the transaction code at a mobile device, and may use the mobile device to conduct the transaction using the transaction code. As another example, particular embodiments may allow a financial institution device to provide a batch payment to a particular merchant for numerous transactions that have been conducted between customers and the particular merchant. This may allow the financial institution device to pay for each of these transactions through a single payment, as opposed to having to provide an individual payment for each transaction.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a system that facilitates transactions between customers and merchants;

FIG. 2A illustrates an example request that may be received by a financial institution device in order to facilitate a transaction between a customer and a merchant;

FIG. 2B illustrates an example transaction code that may be used to conduct a transaction between a customer and a merchant;

FIG. 2C illustrates example transaction information associated with a transaction between a customer and a merchant; and

FIG. 3 illustrates a method for facilitating transactions between customers and merchants.

### DETAILED DESCRIPTION OF THE DRAWINGS

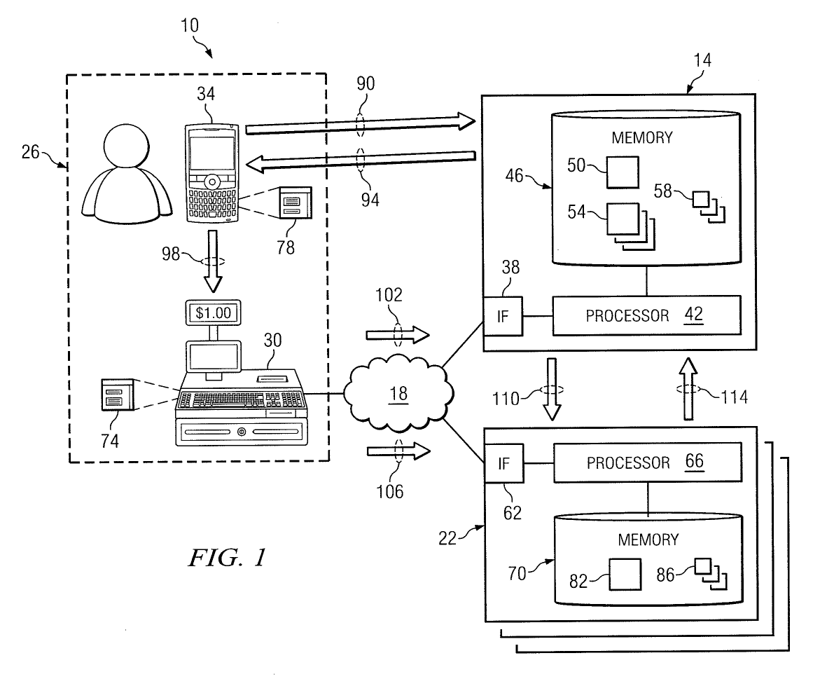

Embodiments of the present disclosure are best understood by referring to FIGS. 1 through 3 of the drawings, like numerals being used for like and corresponding parts of the various drawings.

FIG. 1 illustrates a system 10 that facilitates transactions between customers and merchants. System 10 includes a financial institution device 14 that receives transaction information over one or more networks 18 in order to facilitate transactions between customers and merchants. After receiving transaction information for numerous transactions between customers and a particular merchant, financial institution device 14 communicates a batch payment to a merchant device 22 associated with the particular merchant. In particular embodiments, this may allow merchant device 22 to reconcile each of the transactions. System 10 further include a transaction environment 26 that communicates the transaction information to financial institution device 14. Transaction environment 26 includes one or more transaction devices 30 that perform transactions between customers and merchants based on transaction codes provided by one or more mobile devices 34 associated with the customers. In particular embodiments, system 10 may allow customers to conduct transactions with a particular merchant using mobile devices 34 and transaction codes, and may further allow each of the transactions to be reconciled based on a batch payment provided by the financial institution device 14.

A financial institution represents an institution, such as a bank, that communicates with customers and merchants in order to facilitate transactions between the customers and merchants. The financial institution facilitates transactions for customers that have a credit card account, a savings account, a debit card account, a checking account, or any other account associated with the financial institution.

A merchant represents an entity in any suitable industry that conducts a transaction with a customer. The merchant may include a retailer, a wholesaler, a service company, or any other suitable entity that has customers and conducts transactions with the customers. The transaction may include receiving payment for goods or services from the customer or crediting a refund to the customer. The merchant interacts with the financial institution associated with a customer in order to facilitate each transaction.

In order to conduct a transaction with a merchant, a customer typically pays for a goods or services received from the merchant using money, a check, and/or credit/debit cards. Payments using credit/debit cards may be problematic for various reasons. For example, credit/debit cards are susceptible to fraud, which can effect the customer, merchant, and/or the financial institution associated with the customer. As another example, credit/debit cards require a merchant to pay substantial fees in order to receive payment for transactions using these credit/debit cards. Since particular merchants may conduct hundreds of thousands of transactions per day using credit/debit cards, these fees may add up very quickly, hurting the profitability of a merchant. As such, in particular embodiments, system 10 of FIG. 1 may facilitate transactions between customers and merchants that may provide various advantages. For example, system 10 may facilitate transactions between customers and merchants by providing a customer with a transaction code that may be used to conduct the transaction. Furthermore, in particular embodiments, after a number of transactions have been conducted with a particular merchant (such as 100 transactions conducted between 100 different customers and the particular merchant), a financial institution associated with each of the customers may provide a batch payment to the particular merchant, so that the merchant may reconcile each of these transactions. As such, system 10 may facilitate transactions between customers and merchants in a manner that is advantageous to both the customers and the merchants.

Financial institution device 14 represents any suitable components that facilitate transactions between customers and merchants. Financial institution device 14 may include a network server, any suitable remote server, a mainframe, a host computer, a workstation, a web server, a personal computer, a file server, or any other suitable device operable to facilitate transactions between customers and merchants. The functions of financial institution device 14 may be performed by any suitable combination of one or more servers or other components at one or more locations. In the embodiment where the module is a server, the server may be a private server, and the server may be a virtual or physical server. The server may include one or more servers at the same or remote locations. Also financial institution device 14 may include any suitable component that functions as a server. In the illustrated embodiment, financial institution device 14 includes a network interface 38, a processor 42, and a memory 46.

Network interface 38 represents any suitable device operable to receive information from network 18, transmit information through network 18, perform processing of information, communicate to other devices, or any combination of the preceding. For example, network interface 38 receives transaction information associated with a transaction between a customer and a merchant. As another example, network interface 38 communicates a batch payment to merchant device 22. Network interface 38 represents any port or connection, real or virtual, including any suitable hardware and/or software, including protocol conversion and data processing capabilities, to communicate through a local area network (LAN), a metropolitan area network (MAN), a wide area network (WAN), or other communication system that allows financial institution device 14 to exchange information with network 18, merchant devices 22, transaction environment 26, transaction device 30, mobile device 34, or other components of system 10.

Processor 42 communicatively couples to network interface 38 and memory 46, and controls the operation and administration of financial institution device 14 by processing information received from network interface 38 and memory 46. Processor 42 includes any hardware and/or software that operates to control and process information. For example, processor 42 executes financial institution device management application 50 to control the operation of financial institution device 14. Processor 42 may be a programmable logic device, a microcontroller, a microprocessor, any suitable processing device, or any suitable combination of the preceding.

Memory 46 stores, either permanently or temporarily, data, operational software, or other information for processor 42. Memory 46 includes any one or a combination of volatile or non-volatile local or remote devices suitable for storing information. For example, memory 46 may include random access memory (RAM), read only memory (ROM), magnetic storage devices, optical storage devices, or any other suitable information storage device or a combination of these devices. While illustrated as including particular modules, memory 46 may include any suitable information for use in the operation of financial institution device 14.

In the illustrated embodiment, memory 46 includes financial institution device management application 50, account information 54, and financial institution transaction data 58. Financial institution device management application 50 represents any suitable set of instructions, logic, or code embodied in a computer-readable storage medium and operable to facilitate the operation of financial institution device 14. Account information 54 represents any information regarding user and/or commercial accounts handled by financial institution device 14. For example, account information 54 includes account numbers, nicknames for accounts, account identifiers associated with an account, balance information of an account, limits of an account, disclaimers associated with an account, customer preferences, any other suitable data, or any suitable combination of the preceding. In particular embodiments, account information 54 represents any information regarding an account for each of the individual and/or corporate customers associated with a financial institution. Financial institution transaction data 58 represents any suitable data associated with a transaction performed by a customer. For example, financial institution transaction data 58 may refer to transaction information received from transaction device 30 once a transaction has been conducted. In particular embodiments, financial institution device 14 may aggregate all of the financial institution transaction data 58 associated with transactions that were conducted with a particular merchant, and use this aggregated financial institution transaction data 58 in order to generate a batch payment for the particular merchant.

Network 18 represents any suitable network operable to facilitate communication between the components of system 10, such as financial institution device 14, merchant devices 22, transaction environment 26, transaction device 30, and mobile device 34. Network 18 may include any interconnecting system capable of transmitting audio, video, signals, data, messages, or any combination of the preceding. Network 18 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the components.

Merchant devices 22 represent any suitable components that reconcile transactions between customers and a particular merchant associated with each merchant device 22. In particular embodiments, each merchant device 22 may be associated with a particular merchant, and further associated with one or more transaction devices 30. For example, a particular merchant may be a retail chain that sells goods to customers. This merchant may have numerous transaction devices 30 that allow customers to pay for the goods purchased from the merchant. The particular merchant may further have one or more merchant devices 22 that may reconcile each of these transactions. For example, information regarding each transaction performed at transaction devices 30 may be communicated to merchant device 22. Using this information, merchant device 22 may keep track of each of these transactions, and upon receiving a batch payment for the transactions from financial institution device 14, merchant device 22 may reconcile the transactions. As such, the particular merchant may determine that each of the transactions previously conducted have been paid for.

Merchant device 22 may include a network server, any suitable remote server, a mainframe, a host computer, a workstation, a web server, a personal computer, a file server, or any other suitable device operable to reconcile transactions between customers and a particular merchant. The functions of merchant device 22 may be performed by any suitable combination of one or more servers or other components at one or more locations. In the embodiment where the module is a server, the server may be a private server, and the server may be a virtual or physical server. The server may include one or more servers at the same or remote locations. Also merchant device 22 may include any suitable component that functions as a server. In the illustrated embodiment, merchant device 22 includes a network interface 62, a processor 66, and a memory 70.

Network interface 62 represents any suitable device operable to receive information from network 18, transmit information through network 18, perform processing of information, communicate to other devices, or any combination of the preceding. For example, network interface 62 receives transaction information associated with a transaction between a customer and a merchant. As another example, network interface 62 communicates a payment to financial institution device 14. Network interface 62 represents any port or connection, real or virtual, including any suitable hardware and/or software, including protocol conversion and data processing capabilities, to communicate through a LAN, a MAN, a WAN, or other communication system that allows merchant device 22 to exchange information with financial institution device 14, network 18, transaction environment 26, transaction device 30, mobile device 34, or other components of system 10.

Processor 66 communicatively couples to network interface 62 and memory 70, and controls the operation and administration of merchant device 22 by processing information received from network interface 62 and memory 70. Processor 66 includes any hardware and/or software that operates to control and process information. For example, processor 66 executes merchant device management application 82 to control the operation of merchant device 22. Processor 66 may be a programmable logic device, a microcontroller, a microprocessor, any suitable processing device, or any suitable combination of the preceding.

Memory 70 stores, either permanently or temporarily, data, operational software, or other information for processor 66. Memory 70 includes any one or a combination of volatile or non-volatile local or remote devices suitable for storing information. For example, memory 70 may include RAM, ROM, magnetic storage devices, optical storage devices, or any other suitable information storage device or a combination of these devices. While illustrated as including particular modules, memory 70 may include any suitable information for use in the operation of merchant device 22.

In the illustrated embodiment, memory 70 includes merchant device management application 82 and merchant transaction data 86. Merchant device management application 82 represents any suitable set of instructions, logic, or code embodied in a computer-readable storage medium and operable to facilitate the operation of merchant device 22. Merchant transaction data 86 represents any suitable data associated with a transaction performed by a customer with the merchant. For example, merchant transaction data 86 may refer to transaction information received from transaction device 30 once a transaction has been conducted. In particular embodiments, merchant transaction data 86 for a particular transaction may be used by merchant device 22 in order to reconcile the transaction when a batch payment is received from financial institution device 14.

Transaction environment 26 represents any suitable components that allow customers to perform transactions with merchants. According to the illustrated embodiment, transaction environment 26 includes transaction device 30 and mobile device 34. Transaction device 30 represents any suitable components that verify and process a transaction between a customer and a merchant. Transaction device 30 may include a cash register, a vending machine, a point-of-sale terminal, a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10 in order to input, verify, and process a transaction between a customer and a merchant. Transaction device 30 may comprise a user interface, such as a display, a microphone, keypad, credit/debit card terminal, a scanner (such as a barcode scanner), or other appropriate terminal equipment usable by a user.

Transaction device 30 also includes a transaction application 74. Transaction application 74 represents any suitable software or logic that allows transaction device 30 to input, verify, and process a transaction between a customer and a merchant. Transaction application 74 further represents any suitable software or logic that allows transaction information to be generated and communicated to financial institution device 14 and/or merchant device 22. Transaction application 74 further allows a transaction code to be received from mobile device 34.

Mobile device 34 represents any suitable components that may communicate a transaction code to transaction device 30. Mobile device 34 may include a personal computer, a workstation, a laptop, a wireless or cellular telephone, a Smartphone, an electronic notebook, a personal digital assistant, or any other device (wireless, wireline, or otherwise) capable of receiving, processing, storing, and/or communicating information with other components of system 10. Mobile device 34 may comprise a user interface, such as a display, a microphone, keypad, or other appropriate terminal equipment usable by a customer. Mobile device 34 executes a mobile application 78. Mobile application 78 represents any suitable software or logic for receiving, generating, and/or communicating information to other components of system 10 in order for a customer to conduct a transaction with a merchant. The customer associated with mobile device 34 may enter access credentials into mobile application 78 in order to conduct a transaction with transaction device 30. The accessed credentials may include a user name and/or a password.

In an exemplary embodiment of operation, a customer may desire to conduct a transaction with a particular merchant. In order to do so, the customer may use mobile device 34 in order to send a request 90 to financial institution device 14. In response to receiving a request 90, financial institution device 14 may provide a transaction code to mobile device 34 through a transaction code message 94. Once mobile device 34 has received the transaction code, the customer may conduct the transaction with the merchant (in order to purchase goods and services) by providing the transaction code to transaction device 30 via a reception method 98. This may cause the transaction to be conducted. In response to the transaction being conducted, transaction device 30 may communicate transaction information to both financial institution device 14 (via financial institution information message 102) and merchant device 22 (via merchant information message 106).

This method of conducting a transaction may be repeated any number of times and for any number of customers. As such, both financial institution device 14 and merchant device 22 may receive numerous amounts of transaction information associated with each transaction. After a period of time, in order to pay for each of the transactions that occurred during the period of time, financial institution device 14 may communicate a batch payment representing each of the transactions that occurred during the period of time using a batch payment message 110. This may allow financial institution device 14 to pay for each of these transactions through a single payment, as opposed to having to provide an individual payment for each transaction (which for one thousand transactions, would required one thousand different payments). Once batch payment message 110 is received, merchant device 22 may use batch payment message 110 in order to reconcile each of the transactions. Furthermore, merchant device 22 may communicate a payment message 114 back to a financial institution device 14. The payment message 114 may include a payment representing a fee charged by the financial institution for facilitating each of the transactions. Further details regarding particular embodiments of these sequences illustrated in FIG. 1 are discussed below.

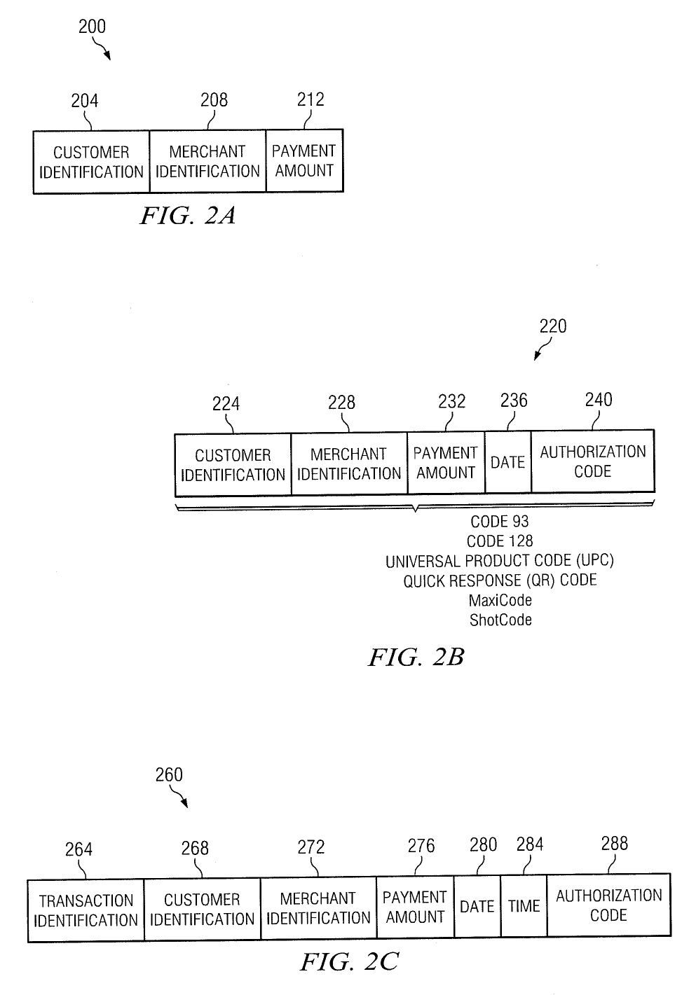

As is stated above, financial institution device 14 receives request 90 to perform a transaction between a customer and a merchant. Request 90 may include any information that allows financial institution device 14 to determine whether to allow the transaction to occur. The information included in request 90 is discussed in further detail in FIG. 2A.

Request 90 may be received by financial institution device 14 from mobile device 34. For example, a customer that desires to conduct a transaction with a merchant may access mobile application 78 on mobile device 34 in order to input one or more pieces of information to be used to generate request 90. In particular embodiments, the customer may input information in any manner. For example, the customer may type in the information using a keyboard on mobile device 34, may select information from a pull-down list displayed on mobile device 34 by mobile application 78, may input the information in any other manner, or any combination of the preceding. In particular, in order to generate request 90, the customer may select a particular merchant from a pull-down list displayed by mobile application 78, and may further input a dollar amount for a transaction.

After financial institution device 14 receives request 90, financial institution device 14 may use request 90 in order to determine whether to approve the transaction associated with request 90. Financial institution device 14 may determine to approve the transaction in any manner. For example, financial institution device 14 may compare a dollar amount of the transaction with a remaining balance in an account associated with the customer.

In response to a determination that the transaction associated with request 90 is approved, financial institution device 14 generates transaction code message 94 for communication to mobile device 34. Transaction code message 94 includes a transaction code. The transaction code may be any type of transaction code. For example, the transaction code may be in the form of a linear bar code (or a one dimensional bar code), such as a code 93, a code 128, or a universal product code (UPC); a matrix bar code (or a two dimensional bar code), such as a quick response (QR) code, a MaxiCode, or a ShotCode; a code that may be transmitted through radio frequencies, such as a code that may be transmitted using near field communications (NFC) or radio frequency identification (RFID); a sequence of numbers and/or symbols; any other transaction code; or any combination of the preceding. The transaction code may include any information that allows a transaction to be performed. The information included in the transaction code is discussed in further detail in FIG. 2B.

Although transaction code message 94 has been described as including a transaction code, in particular embodiments, transaction code message 94 may not include the transaction code. For example, transaction code message 94 may include an approval message that indicates that the transaction has been approved. Based on this approval message, mobile application 78 may generate the transaction code.

After transaction code message 94 has been communicated to mobile device 34, the transaction between the customer and the merchant may be performed. For example, in order to perform the transaction, the customer may cause the transaction code to be received by transaction device 30 by reception method 98. Reception method 98 may represent any method for receiving the transaction code. For example, reception method 98 may represent transaction device 30 scanning the transaction code displayed on mobile device 34. In such an example, the transaction code may be an image in the form of a linear barcode, matrix barcode, a sequence of numbers and/or symbols, any other suitable image, or any combination of the preceding. As another example, reception method 98 may represent transaction device 30 receiving the transaction code based on radio frequencies, such as frequencies associated with NFC or RFID.

After receiving the transaction code, transaction application 74 of transaction device 30 may generate financial institution information message 102 for communication to financial institution device 14. Financial institution information message 102 includes transaction information. The transaction information may include any information that allows a transaction between a customer and a merchant to be facilitated. The information included in the transaction information is discussed in further detail in FIG. 2C. Transaction application 74 may generate financial institution message 102 in any manner. For example, transaction application 74 may extract information from transaction code message 90, and generate financial institution message 102 based on the extracted information. As another example, transaction application 74 may re-bundle transaction code message 94 as financial institution message 102.

After receiving the transaction code, transaction application 74 may also generate merchant information message 106. Merchant information message 106 may allow merchant device 22 to reconcile the transaction between the customer and the merchant. In particular embodiments, merchant information message 106 may include all (or only a portion) of the information included in financial institution message 102.

As is noted above, the sequence of request 90, transaction code message 94, reception method 98, financial institution information message 102, and merchant information message 106 may be repeated for any number of transactions, any number of customers, and any number of merchants. For example, these sequences may be repeated for a second transaction, a third transaction, a fourth transaction, or any other number of transactions. Furthermore, one or more of the transactions may be between the same customer and the same merchant, the same customer and different merchants, different customers and different merchants, and/or different customers and the same merchant.

After a period of time, financial institution device 14 may generate a batch payment message 110 for communication to a particular merchant device 22. The period of time may be any suitable period of time. For example, the period of time may be a second, a minute, an hour, a day, a month, a year, a period of time that it takes for a predetermined amount of transactions to occur between customers and a particular merchant, a period of time determined by a request by a user of financial institution device 14 (such as whenever the user requests the generation of batch payment message 110), or any other suitable period of time.

Batch payment message 110 may include a batch payment. The batch payment represents a payment to a particular merchant for one or more transactions that have been facilitated by financial institution device 14. For example, if fifteen transactions have occurred between one or more customers and a particular merchant, the batch payment may represent a payment based on each of these transactions. In particular embodiments, the batch payment may include a payment that is equal to the payment amount of each of the transactions during the period of time. For example, if a first transaction was for $100 and a second transaction was for $200, the batch payment may include a payment for $300. In particular embodiments, the batch payment may include a payment that is equal to a portion of the payment amount of each of the transactions during the period of time. For example, in order to facilitate each of the transactions, the financial institution may charge a fee to the merchant. The fee may be any suitable fee, such as a set amount (for example, five cents for each transaction) or a variable amount (for example, a percentage of each transaction). As such, if the fee is one percent of each transaction (where a first transaction was for $100 and a second transaction was for $200), the batch payment may include a payment for $297 (the sum of $100 and $200, minus the one percentage fee ($1.00 and $2.00)). In particular embodiments, the fee charged by the financial institution may be lower than the typical fee associated with credit/debit cards.

The batch payment may further identify each transaction represented in the batch payment. For example, the batch payment may include identifying information associated with each transaction. This may allow merchant device 22 to reconcile the batch payment with each of the transactions.

In particular embodiments, in addition to communicating batch payment message 102 to merchant device 22, financial institution device 14 may further withdraw a payment amount from an account associated with a customer. For example, if a customer conducted a transaction that cost $100, financial institution device 14 may withdraw the $100 from an account associated with the customer.

Once batch payment message 110 is communicated to merchant device 22, merchant device 22 may receive batch payment message 110 and reconcile one or more transactions using the batch payment included in batch payment message 110. For example, merchant device 22 may compare the batch payment with transaction information for a first transaction (which was included in merchant information message 106). Such a comparison may include comparing the payment in the batch payment associated with the first transaction with the transaction information for the first transaction. As an example, when the batch payment includes a $200 payment that is associated with a first transaction, merchant device 22 may compare this payment amount with the transaction information for the first transaction (which may indicate that the first transaction was for $200). In particular embodiments, such reconciliation may occur for each transaction included in the batch payment.

In addition to reconciling the transactions, merchant device 22 may further generate payment message 114 for communication to financial institution device 14. Payment message 114 includes a payment representing a fee charged by the financial institution for facilitating each of the transactions between customers and the particular merchant. For example, in order to facilitate each of the transactions, the financial institution may charge a fee to the merchant. The fee may be any suitable fee, such as a set amount (for example, five cents for each transaction) or a variable amount (for example, a percentage of each transaction). As such, if the fee is one percent of each transaction (where a first transaction was for $100 and a second transaction was for $200), the payment may be for $3 (one percent of $300). In particular embodiments, the fee charged by the financial institution may be lower than the typical fee associated with credit/debit cards. In particular embodiments, merchant device 22 may not generate payment message 114 when the fee charged by the financial institution is already deducted from the batch payment included in batch payment message 110.

Although FIG. 1 illustrates mobile device 34 and mobile application 78 generating request 90 and receiving transaction code 94, in particular embodiments, these sequences may be performed by transaction device 30 and transaction application 74. For example, transaction device 30 may request permission to conduct a transaction on the customer's behalf, and receive (or generate) the transaction code for the transaction. Furthermore, mobile device 34 may receive the transaction code from transaction device 30 via reception method 98. Additionally, mobile device 34 may communicate financial institution information message 102 to financial institution device 14 and merchant information message 106 to merchant device 22.

Modifications, additions, or omissions may be made to system 10 without departing from the scope of the invention. For example, financial institution device 14 may facilitate any number of transactions that are performed using any number of transaction environments 26, transaction devices 30, mobile devices 34, customers, and/or merchants. Additionally, system 10 may include any number of financial institution devices 14, networks 18, merchant devices 22, transaction environments 26, transaction devices 30, and/or mobile devices 34. Any suitable logic may perform the functions of system 10 and the components within system 10.

FIG. 2A illustrates an example request 200 that may be received by financial institution device 14 in order to facilitate a transaction between a customer and a merchant. In particular embodiments, request 200 may be an example of request 90 of FIG. 1. According the illustrated embodiment, request 200 includes customer identification 204, merchant identification 208, and payment amount 212.

Customer identification 204 represents any data that may identify a particular customer. For example, customer identification 204 may include the customer's name, the customer's address, the customer's social security number, an online identifier associated with the customer, an account number associated with the customer, any other information that identifies the customer, or any combination of the preceding. In particular embodiments, financial institution device 14 may utilize customer identification 204 in order to determine which customer is providing request 200.

Merchant identification 208 represents any data that may identify a merchant with which the customer desires to conduct a transaction with. For example, merchant identification 208 may include the merchant's name, the merchant's address, an identifier associated with the merchant, any other data that identifies the merchant, or any combination of the preceding. In particular embodiments, financial institution device 14 may utilize merchant identification 208 in order to determine with which merchant the customer desires to conduct a transaction. In particular embodiments, merchant identification 208 may assist financial institution device 14 in determining whether or not to approve the transaction. For example, financial institution device 14 may use merchant identification 208 to determine that the merchant is no longer in good standing with the financial institution, or to determine that the merchant has not signed up for this service with the financial institution. As such, financial institution device 14 may determine not to approve the transaction.

Payment amount 212 represents any data that may identify an amount of money that is needed to conduct the transaction between the customer and the merchant. For example, payment amount 212 may include any suitable amount of money, such as $1, $10, $100, $1,000 dollars, or any other appropriate amount.

In particular embodiments, request 200 may include any other information. For example, request 200 may include information associated with a date, a time, the global positioning system (GPS) location of mobile device 34, or any other information.

In particular embodiments, the information included in request 200 may be generated in any manner. For example, a customer that desires to conduct a transaction with the merchant may access mobile application 78 on mobile device 34 in order to input one or more pieces of information to be included in request 200. The customer may input the information in any manner. For example, the customer may type in the information using a keyboard on mobile device 34, may select information from a pull-down list displayed on mobile device 34 by mobile application 78, may input the information in any other manner, or any combination of the preceding. In particular embodiments, the information included in request 200 may be pre-filled. For example, when the customer accesses mobile application 78 on mobile device 34, customer identification 204 may be pre-filled based on an identifier associated with mobile device 34 or based on an identifier associated with mobile application 78. In a particular embodiment, the information inputted by a customer may be different than the information included in request 200. For example, the customer may input the name of a particular merchant, and based on that selected name, mobile application 78 may associate a particular identifier with the merchant and include that identifier as merchant identification 208 (as opposed to the name inputted by the customer).

FIG. 2B illustrates an example transaction code 220 that may be used to conduct a transaction between a customer and a merchant. In particular embodiments, transaction code 220 may be an example of the transaction code provided to mobile device 34 in transaction code message 94, and further received by transaction device 30 via reception method 98 in order to perform the transaction. According to the illustrated embodiment, transaction code 220 includes customer identification 224, merchant identification 228, payment amount 232, date 236, and authorization code 240.

Customer identification 224 represents any data that may identify a particular customer. In particular embodiments, customer identification 224 of FIG. 2B may be substantially similar to customer identification 204 of FIG. 2A. In particular embodiments, customer identification 224 of FIG. 2B may be different than customer identification 204 of FIG. 2A. For example, although both customer identification 224 of FIG. 2B and customer identification 204 of FIG. 2A may identify the same customer, a different type of identifier may be used as customer identification 224 of FIG. 2B than customer identification 204 of FIG. 2A. As an example, customer identification 224 of FIG. 2B may identify the customer by an account number associated with the customer, and customer identification 204 of FIG. 2A might identify the customer by an online identification associated with the customer. In particular embodiments, these differences may be the result of different accounting practices used by the financial institution and the merchant, different software used by the financial institution and the merchant, different information requirements of the financial institution and the merchant, or any other difference between the financial institution and the merchant.

Merchant identification 228 represents any data that may identify a merchant with which the customer desires to conduct a transaction. In particular embodiments, merchant identification 228 of FIG. 2B may be substantially similar to merchant identification 208 of FIG. 2A. In particular embodiments, although merchant identification 228 of FIG. 2B and merchant identification 208 of FIG. 2A may identify the same merchant, merchant identification 228 of FIG. 2B may be different than merchant identification 208 of FIG. 2A. In particular embodiments, these differences may be the result of different accounting practices used by the financial institution and the merchant, different software used by the financial institution and the merchant, different information requirements of the financial institution and the merchant, or any other difference between the financial institution and the merchant.

Payment amount 232 represents any data that may identify an amount of money that is needed to conduct the transaction between the customer and the merchant. In particular embodiments, payment amount 232 of FIG. 2B may be substantially similar to payment amount 212 of FIG. 2A. In particular embodiments, although payment amount 232 of FIG. 2B and payment amount 212 of FIG. 2A may identify the same amount of money, payment amount 232 may be different than payment amount 212 of FIG. 2A. In particular embodiments, these differences may be the result of different accounting practices used by the financial institution and the merchant, different software used by the financial institution and the merchant, different information requirements of the financial institution and the merchant, or any other difference between the financial institution and the merchant.

Date 236 may represent any data that may identify a date associated with the transaction. In particular embodiments, by providing date 236, transaction code 220 may be only valid on that date. As such, if the customer requests a transaction on a first day, but does not attempt the transaction until a second day, the transaction may be denied by transaction device 30.

Authorization code 240 may represent an authorization of the transaction provided by the financial institution. In particular embodiments, authorization code 240 may be used to prevent fraud in transactions. For example, authorization code 240 may allow transaction device 30 to determine that transaction code 220 is authentic. As such, without a proper a proper authorization code 240, transaction device 30 may refuse to conduct the transaction with a customer. In particular embodiments, authorization code 240 may be a code that is only known by the financial institution and the merchant. In particular embodiments, authorization code 240 may change periodically, so as to further prevent fraud.

In particular embodiments, transaction code 220 may include any other information. For example, transaction code 220 may include a unique identifier that prevents transaction code 220 from being used multiple times, a time period for which transaction code 220 is valid, or any other information.

Transaction code 220 may be in any type of form. For example, transaction code 220 may be in the form of an image, such as a linear bar code (e.g., a code 93, a code 28, or a UPC), a matrix bar code (e.g., a QR code, a MaxiCode, or a ShotCode), a sequence of numbers and/or symbols, any other image, or any combination of the preceding. As another example, transaction code may be in the form of a communication that may be transmitted according to frequencies associated with NFC or RFID.

In particular embodiments, the information included in transaction code 220 may be embedded in transaction code 220. For example, in particular embodiments where transaction code 220 is in the form of a barcode, one or more bars in the bar code may represent each item of information included in transaction code 220.

FIG. 2C illustrates example transaction information 260 associated with a transaction between a customer and a merchant. In particular embodiments, transaction information 260 may be an example of the transaction information communicated to financial institution device 14 (via financial institution information message 102) and/or communicated to merchant device 22 (via merchant information message 106). According the illustrated embodiments, transaction information 260 includes transaction identification information 264, customer identification 268, merchant identification 272, payment amount 276, date 280, time 284, and authorization code 288.

Transaction identification 264 may represent any data that may identify the transaction that was conducted. In particular embodiments, each conducted transaction may have a different transaction identification 264. As such, transaction identification 264 may uniquely identify each particular transaction. In particular embodiments, transaction identification 264 may be used to identify payment amount 276 as being associated with a particular transaction. For example, when financial institution device 14 generates the batch payment for a particular merchant, each transaction identification 264 may be included with the batch payment so that merchant device 22 can identify which transactions are being paid for in the batch payment. Thus, merchant device 22 may reconcile each of the transactions.

Customer identification 268 represents any data that may identify a particular customer. In particular embodiments, customer identification 268 of FIG. 2C may be substantially similar to customer identification 224 of FIG. 2B. In particular embodiments, although customer identification 268 of FIG. 2C and customer identification 224 of FIG. 2B may identify the same customer, customer identification 268 of FIG. 2C may be different than customer identification 224 of FIG. 2B. In particular embodiments, these differences may be the result of different accounting practices used by the financial institution and the merchant, different software used by the financial institution and the merchant, different information requirements of the financial institution and the merchant, or any other difference between the financial institution and the merchant.

Merchant identification 272 represents any data that may identify a merchant that the customer conducted a transaction with. In particular embodiments, merchant identification 272 of FIG. 2C may be substantially similar to merchant identification 228 of FIG. 2B. In particular embodiments, although merchant identification 272 of FIG. 2C and merchant identification 228 of FIG. 2B may identify the same merchant, merchant identification 272 of FIG. 2C may be different than merchant identification 228 of FIG. 2B. In particular embodiments, these differences may be the result of different accounting practices used by the financial institution and the merchant, different software used by the financial institution and the merchant, different information requirements of the financial institution and the merchant, or any other difference between the financial institution and the merchant.

Payment amount 276 represents any data that may identify an amount of money that was used to pay for the transaction. In particular embodiments, payment amount 276 of FIG. 2C may be substantially similar to payment amount 232 of FIG. 2B. In particular embodiments, although payment amount 276 of FIG. 2C and payment amount 232 of FIG. 2B may identify the same amount of money, payment amount 276 of FIG. 2C may be different than payment amount 232 of FIG. 2B. In particular embodiments, these differences may be the result of different accounting practices used by the financial institution and the merchant, different software used by the financial institution and the merchant, different information requirements of the financial institution and the merchant, or any other difference between the financial institution and the merchant.

Date 280 may represent any data that may identify a date associated with the transaction. In particular embodiments, date 280 of FIG. 2C may be substantially similar to date 236 of FIG. 2B. In particular embodiments, although date 280 of FIG. 2C and date 236 of FIG. 2B may identify the same date, date 280 of FIG. 2C may be different than date 236 of FIG. 2B. In particular embodiments, these differences may be the result of different accounting practices used by the financial institution and the merchant, different software used by the financial institution and the merchant, different information requirements of the financial institution and the merchant, or any other difference between the financial institution and the merchant.

Time 284 may represent any data that may identify a time associated with the transaction. In particular embodiments, time 284 may be used as a further identifier of the particular transaction that has been conducted.

Authorization Code 288 may represent an authorization of the transaction provided by the financial institution. In particular embodiments, authorization code 288 may be used to prevent fraud in transactions. For example, authorization code 288 may be used by financial institution device 14 to determine that authorization was given for a particular transaction, and also to determine that the information included in transaction information 260 is the same information for which authorization was given. For example, by comparing payment amount 232 (associated with authorization code 240) with payment amount 276 (associated with authorization code 288), financial institution device 14 may be able to determine whether the payment amounts are different, and, if so, may initiate an investigation. In particular embodiments, authorization code 288 of FIG. 2C may be substantially similar to authorization code 240 of FIG. 2B. In particular embodiments, although authorization code 288 of FIG. 2C and authorization code 240 of FIG. 2B may represent the same authorization provided by the financial institution, authorization code 288 of FIG. 2C may be different than authorization code 240 of FIG. 2B. In particular embodiments, these differences may be the result of different accounting practices used by the financial institution and the merchant, different software used by the financial institution and the merchant, different information requirements of the financial institution and the merchant, or any other difference between the financial institution and the merchant.

In particular embodiments, transaction information 260 may include any other information associated with a transaction. For example, transaction information 260 may include data that identifies the goods or services purchased in the transaction, a unique identifier that prevents the transaction information from being used multiple times (so as to prevent fraud), further authorization provided by transaction device 30 so that financial institution device 14 and/or merchant device 22 may determine that transaction information 260 is authentic, or any other information.

In particular embodiments, although the same transaction information 260 has been described as being communicated to both financial institution device 14 and merchant device 22, in particular embodiments, financial institution device 14 and merchant device 22 may receive different versions of transaction information 260. For example, more or less (or even different) information may be included in transaction information 260 communicated to financial institution device 14 than is communicated to merchant device 22. In particular embodiments, these differences may be the result of different accounting practices used by the financial institution and the merchant, different software used by the financial institution and the merchant, different information requirements of the financial institution and the merchant, or any other difference between the financial institution and the merchant.

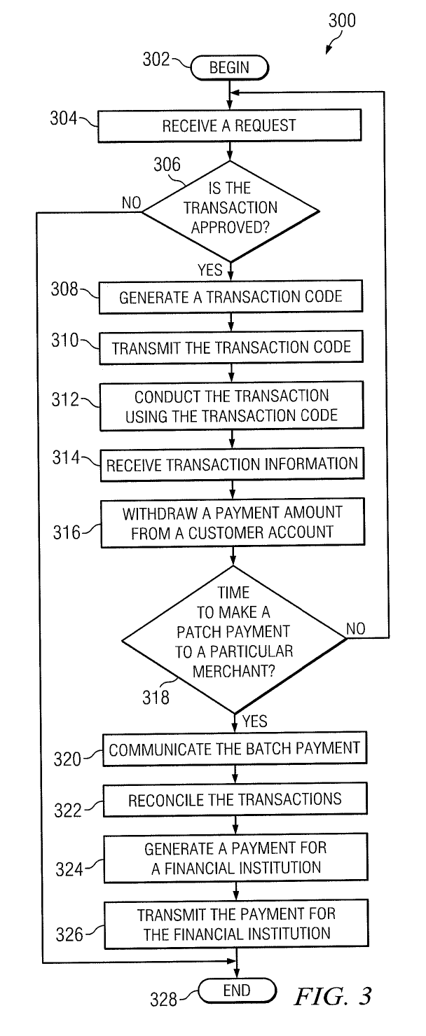

FIG. 3 illustrates a method 300 for facilitating transactions between customers and merchants. In particular embodiments, one or more steps of method 300 may be performed by financial institution device 14, merchant device 22, transaction device 30, and/or mobile device 34.

The method begins at step 302. At step 304, a request to perform a transaction between a customer and merchant is received. In particular embodiments, the request may be received by financial institution device 14. In particular embodiments, a request may include a payment amount, a customer identification, and a merchant identification.

At step 306, it is determined whether the transaction between the customer and the merchant is approved. In particular embodiments, financial institution device 14 may determine to approve the transaction in any manner. For example, financial institution device 14 may compare a dollar amount of the transaction with a remaining balance in an account associated with the customer. If the transaction is not approved, the method moves to step 328 where the method ends. If the transaction is approved, the method moves to step 308.

At step 308, a transaction code is generated. In particular embodiments, the transaction code may be generated by financial institution device 14. In particular embodiments, the transaction code is generated in response to a determination that the request for the transaction is approved. In particular embodiments, the transaction code may be generated based on the payment amount, the customer identification, and the merchant identification. In particular embodiments, the transaction code may be used to conduct the transaction. In particular embodiments, the transaction code may be an image in the form of a linear bar code (such as a code 93, a code 128, or a UPC) or a matrix bar code (such as a QR code, a MaxiCode, or a ShotCode).

At step 310, the transaction code is transmitted. In particular embodiments, the transaction code may be transmitted by financial institution device 14 to mobile device 34. In particular embodiments, the transaction code may be transmitted using transaction code message 94.

At step 312, the transaction is conducted using the transaction code. In particular embodiments, the transaction may be conducted by transaction device 30 and mobile device 34. For example, a transaction code may be provided to transaction device 30 by mobile device 34 in order to conduct the transaction. In particular embodiments, transaction device 30 may receive the transaction code in any manner. For example, mobile application 78 executed on mobile device 34 may display the transaction code, and transaction application 74 executed on transaction device 30 may scan the displayed transaction code in order to receive the transaction code. In particular embodiments, based on scanning the displayed transaction code, the transaction may be conducted. In particular embodiments, after the transaction is conducted, transaction device 30 may generate transaction information and transmit the transaction information.

At step 314, the transaction information is received. In particular embodiments, the transaction information is received by financial institution device 14. In particular embodiments, financial institution device 14 may receive the transaction information via financial institution information message 102. In particular embodiments, the transaction information includes a transaction identification, the payment amount, the customer identification, and the merchant identification. In particular embodiments, the transaction information is further received by merchant device 22. In particular embodiments, merchant device 22 may receive the transaction information via merchant information message 106. In particular embodiments, the transaction information includes the transaction identification, the payment amount, the customer identification, and the merchant identification.

At step 316, a payment amount may be withdrawn from a customer account. In particular embodiments, the payment amount may be withdrawn from the customer account by financial institution device 14. In particular embodiments, the payment amount may be withdrawn based on the received transaction information.

At step 318, it is determined whether it is time to make a batch payment to a particular merchant. If it is not time, the method moves back to step 304 where another request for a transaction is received. As such, steps 304-316 may be repeated for one or more additional transactions. This may allow any number of transactions to occur between any number of customers and the particular merchant.

At step 318, if it is time to make the batch payment to the particular merchant, the method moves to step 320. At step 320, the batch payment is communicated. In particular embodiments, the batch payment is communicated by financial institution device 14 to a merchant device 22 associated with a particular merchant. The batch payment may include a payment for each of the transactions that occurred between customers and the particular merchant during a particular period time. For example, if 1,000 transactions occurred between customers and the particular merchant, the batch payment may include a payment for each of these 1,000 transactions. In particular embodiments, the batch payment may further identify each of the transactions included in the batch payment. For example, if a first transaction was made for an amount of $300, the batch payment may include $300 and information that identifies that $300 as payment for the first transaction. Furthermore, if a second transaction was for $700, the batch payment may also include $700, and information that identifies that $700 as payment for the second transaction.

At step 322, the transactions are reconciled. In particular embodiments, the transactions are reconciled by merchant device 22. For example, merchant device 22 may store transaction information communicated (via merchant information message 106) from transaction device 30 to merchant device 22 for each transaction. As such, merchant device 22 may reconcile each transaction that occurred during the period of time associated with the batch payment. In particular, based on the transaction information, merchant device 22 may determine that the first transaction was, as an example, for $300. Furthermore, the merchant device 22 may further determine that the batch payment includes a $300 payment that is identified as being the payment for the first transaction. Based on these determinations, merchant device 22 may reconcile the first transaction. Furthermore, merchant device 22 may further reconcile each of the other transactions represented in the batch payment.

At step 324, a payment is generated for a financial institution. In particular embodiments, the payment is generated by merchant device 22. For example, in order to facilitate each of the transactions, the financial institution may charge a fee to the merchant. Thus, once each of the transactions is reconciled, merchant device 22 may generate the payment associated with the fee.

At step 326, the payment for the financial institution is transmitted. In particular embodiments, the payment for the financial institution is transmitted by merchant device 22. After the payment for the financial institution is transmitted at step 326, the method moves to step 328 where the method ends.

Modifications, additions, or omissions may be made to method 300. For example, although method 300 illustrates the transaction code being generated and transmitted to financial institution device 14, in particular embodiments, financial institution device 14 may transmit an approval of the transaction to mobile device 34, and mobile device 34 may use the approval to generate the transaction code. Additionally, steps in FIG. 4 may be performed in parallel or in any suitable order.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system comprising:
a memory operable to store customer account information associated with first and second customers; and
a processor operable to:
receive a request to perform a first transaction, the request to perform the first transaction comprising a first payment amount, a first customer identification, and a first merchant identification for a particular merchant;
in response to a determination that the request to perform the first transaction is approved:
generate a first transaction code based on the first payment amount, the first customer identification, and the first merchant identification; and
transmit the first transaction code to a mobile device associated with the first customer, wherein the first transaction code is operable to be used to conduct the first transaction;
receive transaction information for the first transaction, the first transaction information comprising a first transaction identification, the first payment amount, the first customer identification, and the first merchant identification for a particular merchant;
withdraw the first payment amount from a first customer account;
receive a request to perform a second transaction, the request to perform the second transaction comprising a second payment amount, a second customer identification, and a second merchant identification for the particular merchant;
in response to a determination that the request to perform the second transaction is approved:
generate a second transaction code based on the second payment amount, the second customer identification, and the second merchant identification; and
transmit the second transaction code to a mobile device associated with the second customer, wherein the second transaction code is operable to be used to conduct the second transaction;
receive transaction information for the second transaction, the second transaction information comprising a second transaction identification, the second payment amount, the second customer identification, and the second merchant identification for the particular merchant;
withdraw the second payment amount from a second customer account; and
communicate a batch payment to the particular merchant, the batch payment based at least in part upon the first payment amount and the second payment amount, the batch payment further identifying the first transaction associated with the first payment amount and the second transaction associated with the second payment amount.

2. The system of claim 1, further comprising:
a mobile application for execution on a mobile device associated with the first customer, the mobile application operable, upon execution, to display the first transaction code; and
a transaction application for execution on a transaction device associated with the particular merchant, the transaction application operable, upon execution, to:
scan the displayed first transaction code in order to receive the first transaction code from the mobile application;
generate the transaction information for the first transaction; and
transmit the transaction information for the first transaction.

3. The system of claim 1, wherein the first transaction code is displayed as an image selected from a group consisting of:
a Code 93;
a Code 128;
a Universal Product Code (UPC);
a Quick Response (QR) code;
a MaxiCode; and
a ShotCode.

4. The system of claim 1, wherein the first transaction code includes data selected from a group consisting of:
the first payment amount;
the first customer identification;
the first merchant identification; and
a date associated with the first transaction.

5. The system of claim 1, further comprising:
a merchant device comprising:
a second memory operable to store the transaction information for the first and second transactions; and
a second processor operable to:
receive the batch payment;
reconcile the first transaction based at least in part on the transaction information for the first transaction and the first payment amount associated with the batch payment; and
reconcile the second transaction based at least in part on the transaction information for the second transaction and the second payment amount associated with the batch payment.

6. The system of claim 5, wherein the second processor is further operable to:
generate a payment for a financial institution, the payment for the financial institution being an amount equal to a percentage of the first and second payment amounts; and
transmit the payment for the financial institution.

7. Logic embedded in a computer readable storage medium and operable, when executed by a processor, to:
access customer account information associated with first and second customers;
receive a request to perform a first transaction, the request to perform the first transaction comprising a first payment amount, a first customer identification, and a first merchant identification for a particular merchant;
in response to a determination that the request to perform the first transaction is approved:
generate a first transaction code based on the first payment amount, the first customer identification, and the first merchant identification; and
transmit the first transaction code to a mobile device associated with the first customer, wherein the first transaction code is operable to be used to conduct the first transaction;
receive transaction information for the first transaction, the first transaction information comprising a first transaction identification, the first payment amount, the first customer identification, and the first merchant identification for a particular merchant;
withdraw the first payment amount from a first customer account;
receive a request to perform a second transaction, the request to perform the second transaction comprising a second payment amount, a second customer identification, and a second merchant identification for the particular merchant;
in response to a determination that the request to perform the second transaction is approved:
generate a second transaction code based on the second payment amount, the second customer identification, and the second merchant identification; and
transmit the second transaction code to a mobile device associated with the second customer, wherein the second transaction code is operable to be used to conduct the second transaction;
receive transaction information for the second transaction, the second transaction information comprising a second transaction identification, the second payment amount, the second customer identification, and the second merchant identification for the particular merchant;
withdraw the second payment amount from a second customer account; and
communicate a batch payment to the particular merchant, the batch payment based at least in part upon the first payment amount and the second payment amount, the batch payment further identifying the first transaction associated with the first payment amount and the second transaction associated with the second payment amount.

8. The logic of claim 7, further comprising:
a mobile application for execution on a mobile device associated with the first customer, the mobile application operable, upon execution, to display the first transaction code; and
a transaction application for execution on a transaction device associated with the particular merchant, the transaction application operable, upon execution, to:
scan the displayed first transaction code in order to receive the first transaction code from the mobile application;
generate the transaction information for the first transaction; and
transmit the transaction information for the first transaction.

9. The logic of claim 7, wherein the first transaction code is displayed as an image selected from a group consisting of:
a Code 93;
a Code 128;
a Universal Product Code (UPC);
a Quick Response (QR) code;
a MaxiCode; and
a ShotCode.

10. The logic of claim 7, wherein the first transaction code includes data selected from a group consisting of:
the first payment amount;
the first customer identification;
the first merchant identification; and
a date associated with the first transaction.

11. The logic of claim 7, further comprising:
a management application for execution on a merchant device, the management application operable, upon execution, to:
access the transaction information for the first and second transactions;
receive the batch payment;
reconcile the first transaction based at least in part on the transaction information for the first transaction and the first payment amount associated with the batch payment; and
reconcile the second transaction based at least in part on the transaction information for the second transaction and the second payment amount associated with the batch payment.

12. The logic of claim 11, wherein the management application is further operable, upon execution, to:
generate a payment for a financial institution, the payment for the financial institution being an amount equal to a percentage of the first and second payment amounts; and
transmit the payment for the financial institution.

13. A method comprising:
accessing customer account information associated with first and second customers;
receiving a request to perform a first transaction, the request to perform the first transaction comprising a first payment amount, a first customer identification, and a first merchant identification for a particular merchant;
in response to a determination that the request to perform the first transaction is approved:
generating a first transaction code based on the first payment amount, the first customer identification, and the first merchant identification; and
transmitting the first transaction code to a mobile device associated with the first customer, wherein the first transaction code is operable to be used to conduct the first transaction;
receiving transaction information for the first transaction, the first transaction information comprising a first transaction identification, the first payment amount, the first customer identification, and the first merchant identification for a particular merchant;
withdrawing the first payment amount from a first customer account;
receiving a request to perform a second transaction, the request to perform the second transaction comprising a second payment amount, a second customer identification, and a second merchant identification for the particular merchant;
in response to a determination that the request to perform the second transaction is approved:
generating a second transaction code based on the second payment amount, the second customer identification, and the second merchant identification; and
transmitting the second transaction code to a mobile device associated with the second customer, wherein the second transaction code is operable to be used to conduct the second transaction;
receiving transaction information for the second transaction, the second transaction information comprising a second transaction identification, the second payment amount, the second customer identification, and the second merchant identification for the particular merchant;
withdrawing the second payment amount from a second customer account; and
communicating a batch payment to the particular merchant, the batch payment based at least in part upon the first payment amount and the second payment amount, the batch payment further identifying the first transaction associated with the first payment amount and the second transaction associated with the second payment amount.

14. The method of claim 13, further comprising:
displaying the first transaction code;
scanning the displayed first transaction code in order to receive the first transaction code from the mobile application;
generating the transaction information for the first transaction; and
transmitting the transaction information for the first transaction.

15. The method of claim 13, wherein the first transaction code is displayed as an image selected from a group consisting of:
a Code 93;
a Code 128;
a Universal Product Code (UPC);
a Quick Response (QR) code;
a MaxiCode; and
a ShotCode.

16. The method of claim 13, wherein the first transaction code includes data selected from a group consisting of:
the first payment amount;
the first customer identification;
the first merchant identification; and
a date associated with the first transaction.

17. The method of claim 13, further comprising:
accessing the transaction information for the first and second transactions;
receiving the batch payment;
reconciling the first transaction based at least in part on the transaction information for the first transaction and the first payment amount associated with the batch payment; and
reconciling the second transaction based at least in part on the transaction information for the second transaction and the second payment amount associated with the batch payment.

18. The method of claim 17, further comprising:
generating a payment for a financial institution, the payment for the financial institution being an amount equal to a percentage of the first and second payment amounts; and
transmitting the payment for the financial institution.
